(19) United States
(12) Patent Application Publication
(10) Pub. No.: US 2006/0004785 A1
(43) Pub. Date: Jan. 5, 2006

(54) Saving multiple browser instances as a selectable web project

(75) Inventors: Jeanne Anne Hinegardner, Round Rock, TX (US); Neralla Murali, Austin, TX (US); Prasad Venkata Potluri, Austin, TX (US); Rakesh Sharma, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/860,410

(22) Filed: Jun. 3, 2004

(51) Int. Cl. G06F 17/00

(52) U.S. Cl. 707/100

(57) ABSTRACT

A method, system, and program for saving multiple browser instances as a selectable web project are provided. Multiple browser instances currently open are detected, wherein each of the multiple browser instances accesses a different web address. The multiple browser instances are saved together as a selectable project file, wherein upon selection of the selectable project file the multiple browser instances are concurrently reopened.

### BACKGROUND OF THE INVENTION

1. Technical Field

The present invention relates in general to improved browsers and in particular to improved storage of web pages accessed through browsers. Still more particularly, the present invention relates to storing the web addresses and contents accessed by multiple browser instances as a selectable web project, such that when the web project is selected, the previously stored browser instances previously are automatically reopened.

2. Description of the Related Art

Web browsers have proved themselves as an important and functional interface for users to access the Internet. A user provides a web address to the web browser and the web browser access the server located at the web address, retrieves a web page available at the web address, and controls output of the web page through an output interface.

With the number of web pages available across the Internet and intranets growing each day, a helpful feature offered with many browsers is the option to bookmark a web address. When the user selects to bookmark a web address, the title for the web page and the web address are added to a directory of selectable web addresses. To further organize bookmarks, the user may categorize the web address or file the web address in a folder. One benefit of the list of bookmarks is that the user may quickly access a bookmarked web page again just by selecting the bookmark from the list.

With most browsers, a user may choose to open multiple instances of the browser concurrently. Each instance of the browser accesses a different web address. In one example, where multiple instances of a browser are opened concurrently, each browser instance is represented by a separate browser window which may overlap other open browser windows. Opening multiple browser windows to different pages may be advantageous, for example, where a user is researching a particular topic and wants to quickly jump between the different references.

While bookmarking provides a solution for storing a single web address, when a user has multiple browser instances open concurrently, there is no solution for storing a record of the multiple concurrently accessed web addresses, other than individually bookmarking each web address. In addition, bookmarking is limited in that in the bookmark, only the web address is saved and a network connection must be available to access the web address.

Therefore, in view of the foregoing, it would be advantageous to provide a method, system, and program for storing the web addresses of browser instances under a single selectable web project, such that when the web project is reopened, a browser instances for each of the multiple web addresses is automatically initiated. In addition, it would be advantageous to store the contents of the web pages open in the multiple browser instances in the web project, such that when the web project is reopened, a network connection is not required to access the contents of the previously accessed web pages.

### SUMMARY OF THE INVENTION

Therefore, the present invention provides a method, system, and program for improved cataloguing of viewed web pages. In particular, the present invention provides a method, system, and program for saving multiple browser instances currently open into a single selectable web project file.

When a user selects to save multiple browser instances as a web project file, a web project controller detects which browser instances are currently open and displays a list of the browser instances in an interface for the user to specify the web project file. Within the interface for specifying the web project file, a user is enabled to select from multiple options including, but not limited to, selecting to save all or only a portion of the multiple browser instances, selecting the title of the web project file, selecting a location for storing the web project file, and selecting whether to save the web addresses only or the web addresses and contents of each browser instance. The web project file is then saved according to the specifications of the user. Later, when a user chooses to open the web project file, the multiple browser instances stored in the web project file are concurrently reopened.

The multiple web browser instances currently open may include web browser instances currently open at a single computer system or across multiple computer systems in a network. Further, the web project file may be passed to other users and opened by a different user than the user who originally selected to save the web project file.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system in which clients may access web pages from servers;

FIG. 3 is a block diagram depicting the components of a web project controller in accordance with the method, system, and program of the present invention;

FIG. 4 is a pictorial representation depicting multiple browser instances of the present invention;

FIG. 5 is a pictorial representation of an interface for saving a web project in accordance with the method, system, and program of the present invention;

FIG. 6 is a pictorial representation of an interface for selecting to open a web project in accordance with the method, system, and program of the present invention;

FIG. 7 is a pictorial representation of an interface in which a web project is opened, in accordance with the method, system, and program of the present invention;

FIG. 8 is a high level logic flowchart of a process and program for controlling storage of web projects in accordance with the method, system, and program of the present invention; and

FIG. 9 is a high level logic flowchart of a process and program for controlling the opening of a web project in accordance with the method, system, and program of the present invention.

### DETAILED DESCRIPTION OF THE PREFERRED EMBODIMENT

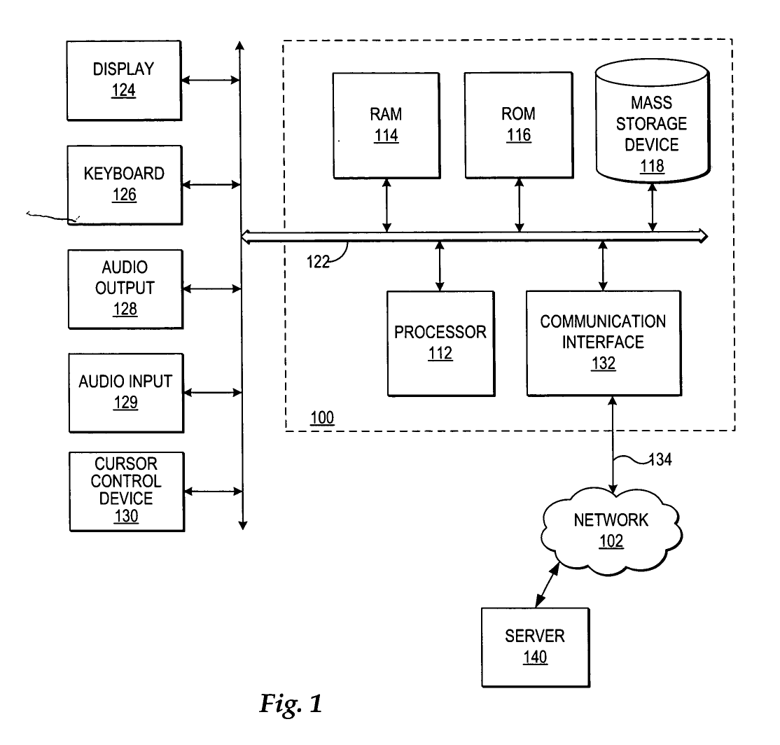

Referring now to the drawings and in particular to FIG. 1, there is depicted one embodiment of a system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system preferably provides a graphical user interface (GUI) to the user. In one embodiment, application or operating system software contains machine executable instructions that when executed on processor 112 carry out the operations depicted in the flowchart of FIG. 5, and other operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Network link 134 in turn provides data communication services through network 102. Network 102 may refer to the worldwide collection of networks and gateways that use a particular protocol, such as Transmission Control Protocol (TCP) and Internet Protocol (IP), to communicate with one another. Network link 134 and network 102 both use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

In addition, computer system 100 typically includes multiple peripheral components that facilitate communication. These peripheral components are connected to multiple controllers, adapters, and expansion slots coupled to one of the multiple levels of bus 122. For example, an audio output device 128 and audio input device 129 are connectively enabled on bus 122 for controlling audio outputs and inputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

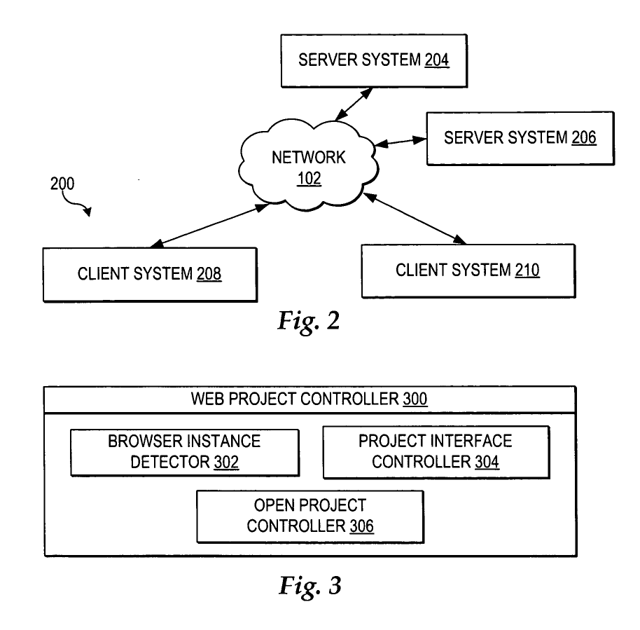

With reference now to FIG. 2, a block diagram depicts a distributed network system in which clients may access web pages from servers. Distributed data processing system 200 is a network of computers in which one embodiment of the invention may be implemented. It will be understood that the present invention may be implemented in other embodiments of systems enabled to communicate via a connection. In the embodiment, distributed data processing system 200 contains network 102, which is the medium used to provide communications links between various devices and computers connected together within distributed data processing system 200. Network 102 may include permanent connections such as wire or fiber optics cables, temporary connections made through telephone connections and wireless transmission connections.

The client/server environment of distributed system 200 includes multiple client systems 208 and 210 communicatively connected to network 102. In addition, there are multiple server systems 204 and 206 communicatively connected to network 102.

The client/server environment of distributed system 200 is implemented within many network architectures. For example, the architecture of the World Wide Web (the Web) follows a traditional client/server model environment. The terms “client” and “server” are used to refer to a computer's general role as a requester of data (the client) or provider of data (the server). In the Web environment, web browsers such as Netscape Navigator™ typically reside on client systems 208 and 210 and render Web documents (pages) served by a web server, such as server systems 204 and 206. Additionally, each of client systems 208 and 210 and server systems 204 and 206 may function as both a “client” and a “server” and may be implemented utilizing a computer system such as computer system 100 of FIG. 1. Further, the present invention is also implemented by client system 208 and 210 engaged in peer-to-peer network communications and downloading via network 102.

The Web may refer to the total set of interlinked hypertext documents residing on servers all around the world. Network 102, such as the Internet, provides an infrastructure for transmitting these hypertext documents between systems connected to network 102. Documents (pages) on the Web may be written in multiple languages, such as Hypertext Markup Language (HTML) or Extensible Markup Language (XML), and identified by Uniform Resource Locators (URLs) that specify the particular web page server from among servers, such as server 204, and pathname by which a file can be accessed, and then transmitted from the particular web page server to an end user utilizing a protocol such as Hypertext Transfer Protocol (HTTP) or file-transfer protocol (FTP). Web pages may further include text, graphic images, movie files, electronic books, sound files, and streaming audio, as well as Java applets and other small embedded software programs that execute when the user activates them by clicking on a link.

Within client system 208, multiple instances of the web browser may be concurrently open, where each instance accesses a different page of content and information accessible for a particular web address from a server system, such as server systems 204 and 206. Each browser instances may require a different window to display the contents of the accessed web page. According to an advantage of the present invention, multiple browser instances may be saved as a web project. The web project may include a selection of the browser instances open on a particular system, such as client system 208, or a selection of the browser instances open on multiple networked systems, such as client systems 208 and 210.

Referring now to FIG. 3, there is depicted a block diagram of the components of a web project controller in accordance with the method, system, and program of the present invention. As illustrated, a web project controller 300 controls saving and opening web projects. It will be understood that web project controller 300 may operate as a stand-alone controller or may operate within a browser.

In particular, web project controller 300 includes a browser instance detector 302. Browser instance detector 302 detects the current browser instances open within a particular computer system or networked group of computer systems. The browser instances may include, but are not limited to, an active browser window, an open but not active browser window, a reduced browser window, and other current instances where a web page is accessed.

In addition, in particular, web project controller 300 includes a project interface controller 304. Project interface controller 304 provides and controls the interface through which a user specifies a web project. When a user requests to save a web project, project interface controller preferably displays the list of current browser instances detected by browser instance detector 302. A user may select to store all or a portion of the current browser instances as a web project. In particular, the user may specify through project interface controller 304 whether to cache the contents of all selected browser instance windows or just the web addresses accessed by the selected browser instances.

An open project controller 306 controls how browser instances are accessed and opened when a web project is opened. In particular, open project controller 306 may adjust how browser instances are accessed and opened when a web project is originally saved at one computer system with one type of browser and opened at another computer system with a different type of browser. In one example, when a web project file is opened, each of the browser instances may either make a connection to the server of web address saved for the browser instance to retrieve the content of the saved web address or, if the content of a browser instance was saved locally, the previously stored content of the browser instance is retrieved from storage.

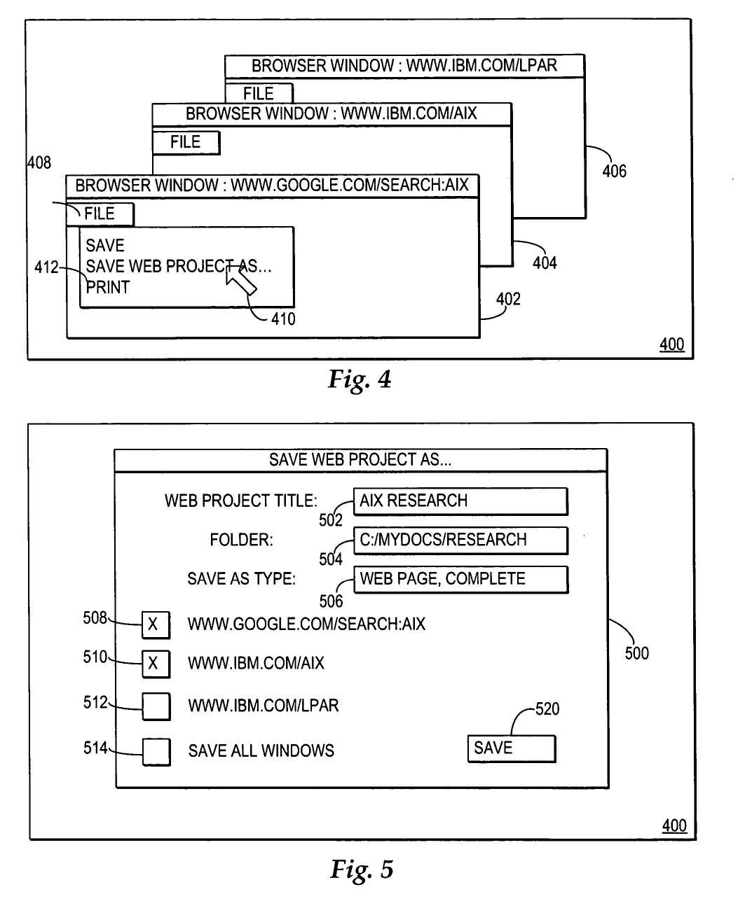

With reference now to FIG. 4, there is depicted a pictorial representation of multiple browser instances of the present invention. As depicted, within display area 400, multiple web browser windows 402, 404, and 406 are open. Each of the browser windows accesses a different web address. For example, window 402 provides an interface with “www.google.com/search:aix”, window 404 provides an interface with “www.ibm.com/aix”, and window 406 provides an interface with “www.ibm.com/lpar”. It will be understood that while in the present example web instances are implemented through web browser windows 402, 404, and 406, in alternate embodiments, web instances may be implemented in other ways. For example, a web browser window may be opened, but reduced from the display area, and still qualify as a web instance.

Each web browser may include multiple selectable menus, such as “file” menu 408. Upon selection of a menu, such as “file” menu 408, a list of selectable options may be displayed. In the example, the user selects “file” menu 408 using a pointer 410 and an option list 412 is displayed. It will be understood that a user may interface with browser windows within display area 400 using pointer 410, keystrokes, and other inputs.

According to an advantage of the present invention, web browsers include a selectable option to save a web project. The web project can include all currently open web instances or a selection of currently open web instances. In the example, the user selects to “save web project as . . . ” to select the option to save a web project. It will be understood that in addition to providing the selectable option to save a web project in a window menu, the user may select to save a web project through other inputs, such as a particular keystroke that initiates saving a web project. Further, it will be understood that the option to save a web project may be available in each browser window, a selection of browser windows, or in a separate graphical window associated with a web browser.

Referring now to FIG. 5, there is depicted a pictorial representation of an interface for saving a web project in accordance with the method, system, and program of the present invention. As depicted, responsive to a user select to save a web project as depicted in FIG. 4, a save web project window 500 is initiated within display area 400. Save web project window 500 provides an interface for a user to specify the web project. In particular, the user may specify the title of the web project, as depicted at reference numeral 502, the location for storage of the web project, as depicted at reference numeral 504, and the type of information to save in the web project as depicted at reference numeral 506. In particular, in the example, the user selects save the complete web page and address, such that the content displayed in each of the selected browser windows is locally saved. Alternatively, for example, a user may select to only save the addresses accessed at each of the selected browser windows, such that when the web project is opened, browser instances are opened that access and display the content currently available at the saved addresses.

Advantageously, the user is also enabled to select which currently open browser instances to store in the web project. As depicted, the addresses accessed by each of the web browser windows in FIG. 4 are now depicted as selectable options 508, 510, and 512 within save web project window 500. Preferably, a user may select which of the browser instances to save or may select option 514 to save all browser instances, which in this example would include all open browser windows. In the example, the user selects to store only two of the web instances in the web project as indicated by the “X” in selectable options 508 and 510.

Once a user is done selecting options for the web project, the user selects selectable option 520 to save the web project. The saved web project is a file that may include a textual document indicating the web addresses of the selected browser instances and may include a graphical image file of the information accessed from the web addresses.

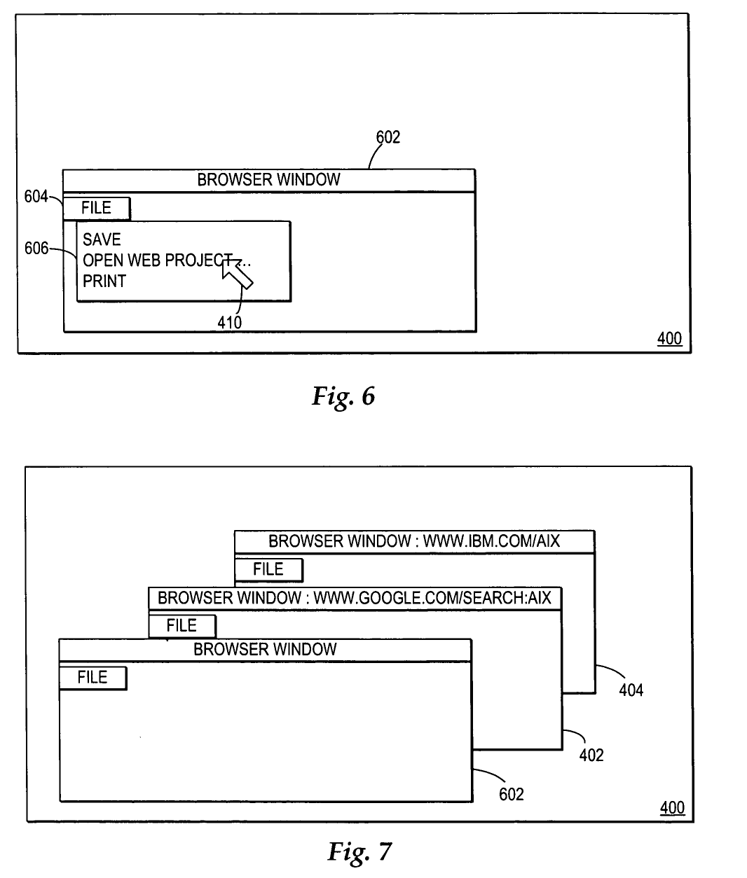

With reference now to FIG. 6, there is depicted a pictorial representation of an interface for selecting to open a web project in accordance with the method, system, and program of the present invention. As depicted, a browser window 602 is open within display area 400. In the example, when a user selects “file” menu 604, selectable options 606 are displayed. Within selectable options 606 is the option to open a web project. In the example, the user uses pointer 410 to select the option to open a web project. It will be understood that other methods of opening a web project including, but not limited to, entry of commands or selection of the web project file, may be implemented.

Referring now to FIG. 7, there is depicted a pictorial representation of an interface in which a web project is opened, in accordance with the method, system, and program of the present invention. As depicted, responsive to a user select to open the web project stored in FIG. 5, the content of the browser windows stored in that web project are opened in display area 400. In the example, browser windows 402 and 402 were selected for the web project in FIG. 5 and are re-opened when the web project is selected. It will be understood that while the example depicts opening and display each of the browser windows in a web project other methods of opening a web project may be implemented.

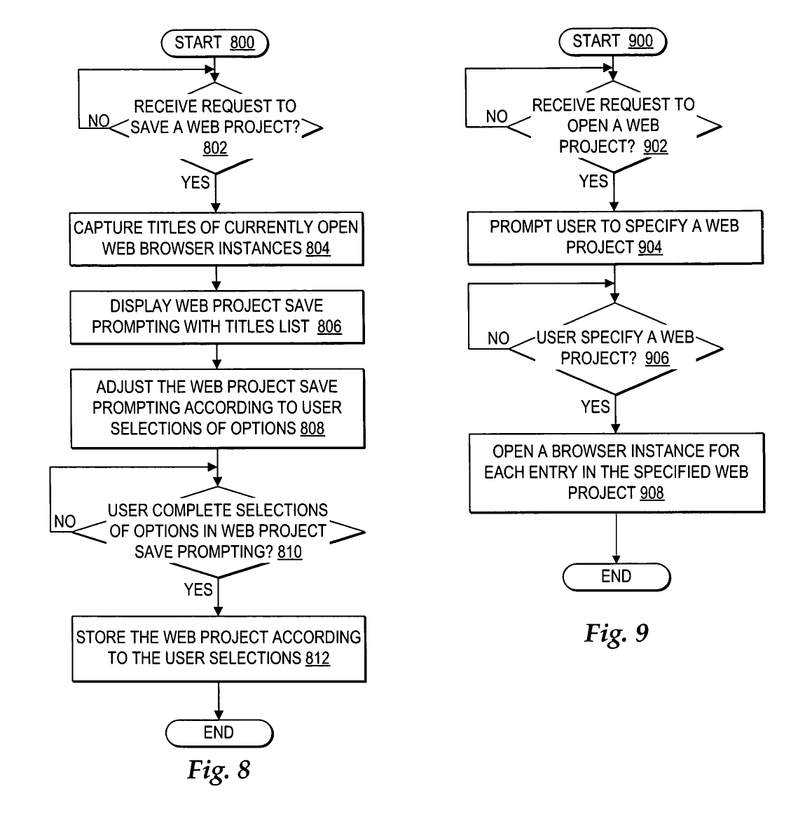

With reference now to FIG. 8, there is depicted a high level logic flowchart of a process and program for controlling storage of web projects in accordance with the method, system, and program of the present invention. As depicted, the process starts at block 800 and thereafter proceeds to block 802. Block 802 depicts a determination whether a request to save a web project is received. If a request to save a web project is not received, then the process iterates at block 802. If a request to save a web project is received, then the process passes to block 804. Block 804 depicts capturing titles of currently open web browser instances. Next, block 806 depicts displaying a web project save prompting with a list of the captured titles. Thereafter, block 808 depicts adjusting the web project save prompting according to user selections of options. In particular, the user may select the location to store the project, the titles of web browsers to store in the project, the type of project storage, and the name of the project. Block 810 depicts a determination whether the user has completed selections of options in the web project save prompting. If the user has not completed selections, then the process iterates at block 810. If the user has completed selections, then the process passes to block 812. Then, block 812 depicts storing the selected browser instance titles according to the type of storage selected by the user as a web project, and the process ends. In particular, if a user selects complete storage as the type of storage, then the contents of each selected web browser instance title are stored in the web project. Alternatively, a user may select to only store web addresses and titles.

Referring now to FIG. 9, there is depicted a high level logic flowchart of a process and program for controlling the opening of a web project in accordance with the method, system, and program of the present invention. As depicted, the process starts at block 900 and thereafter proceeds to block 902. Block 902 depicts a determination whether a request to open a web project is received. If a request to open a web project is not received, then the process iterates at block 902. If a request to open a web project is received, then the process passes to block 904. Block 904 depicts prompting the user to specify a web project to open. Next, block 906 depicts a determination of whether the user has specified a web project. If the user has not yet specified the web project, then the process iterates at block 906. Once the user specifies a particular web project to open, then the process passes to block 908. Block 908 depicts opening a browser instance for each entry in the specified web project, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for storing a record of a plurality of open browser instances, comprising:
detecting a plurality of browser instances currently open, wherein each of said plurality of browser instances accesses a particular network address; and
saving said plurality of browser instances together as a selectable project file, wherein upon selection of said selectable project file said plurality of browser instances are concurrently reopened.

2. The method according to claim 1 for storing a record of a plurality of open browser instances further comprising:
receiving a selection of said plurality of browser instances; and
only saving said selection of said plurality of browser instances as said selectable selectable project file.

3. The method according to claim 1 for storing a record of a plurality of open browser instances further comprising:
saving a web address for each of said plurality of browser instances in said selectable project file.

4. The method according to claim 1 for storing a recording of said plurality of open browser instances further comprising:
saving the contents of each of said plurality of browser instances in said selectable project file.

5. The method according to claim 1 for storing a recording of said plurality of open browser instances further comprising:
receiving a request to store said plurality of browser instances as a selectable project file from an input to one from among said plurality of browser instances.

6. A system for storing a record of a plurality of open browser instances, comprising:
means for detecting a plurality of browser instances currently open, wherein each of said plurality of browser instances accesses a particular network address; and
means for saving said plurality of browser instances together as a selectable project file, wherein upon selection of said selectable project file said plurality of browser instances are concurrently reopened.

7. The system according to claim 6 for storing a record of a plurality of open browser instances further comprising:
means for receiving a selection of said plurality of browser instances; and
means for only saving said selection of said plurality of browser instances as said selectable project file.

8. The system according to claim 6 for storing a record of a plurality of open browser instances further comprising:
means for saving a web address for each of said plurality of browser instances in said selectable project file.

9. The system according to claim 6 for storing a recording of said plurality of open browser instances further comprising:
means for saving the contents of each of said plurality of browser instances in said selectable project file.

10. The system according to claim 6 for storing a recording of said plurality of open browser instances further comprising:
means for receiving a request to store said plurality of browser instances as a selectable project file from an input to one from among said plurality of browser instances.

11. A computer program product, residing on a computer readable medium, for storing a record of a plurality of open browser instances, comprising:
means for detecting a plurality of browser instances currently open, wherein each of said plurality of browser instances accesses a particular network address; and
means for saving said plurality of browser instances together as a selectable project file, wherein upon selection of said selectable project file said plurality of browser instances are concurrently reopened.

12. The computer program product according to claim 11 for storing a record of a plurality of open browser instances further comprising:
means for receiving a selection of said plurality of browser instances; and
means for only saving said selection of said plurality of browser instances as said selectable project file.

13. The computer program product according to claim 11 for storing a record of a plurality of open browser instances further comprising:
means for saving a web address for each of said plurality of browser instances in said selectable project file.

14. The computer program product according to claim 11 for storing a recording of said plurality of open browser instances further comprising:
means for saving the contents of each of said plurality of browser instances in said selectable project file.

15. The computer program product according to claim 11 for storing a recording of said plurality of open browser instances further comprising:
means for receiving a request to store said plurality of browser instances as a selectable project file from an input to one from among said plurality of browser instances.

16. A system for enabling saving a plurality of open browser instances, comprising:
a graphical user interface adapted to receive a selection to record a plurality of browser instances that are currently open as a web project file;
a web project controller adapted to create said web project file of a plurality of web addresses accessed by said plurality of browser instances,
said graphical user interface further adapted to receive a selection to open said web project file, wherein said selection to open said web project file said plurality of browser instances are concurrently reopened in said graphical user interface.

17. The system for enabling saving a plurality of open browser instances, said web project controller further adapted to detect said plurality of browser instances currently open.

18. The system for enabling saving a plurality of open browser instances, said graphical user interface further adapted to display said plurality of browser instances, wherein said user is enabled to make a selection from among said plurality of browser instances for storage in said web project file.
